(19) United States
(12) Patent Application Publication
(10) Pub. No.: US 2025/0169515 A1
(43) Pub. Date: May 29, 2025

(54) CONTINUOUS FEED, HORIZONTAL WATER SPRAY SHELL EGG PASTEURIZATION SYSTEM

(71) Applicant: Aegis Foods LLC, South Holland, IL (US)

(72) Inventors: Jay Berglind, Riverside, IL (US); Lionel Valencia, Lansing, IL (US); Erdogan Ceylan, Orland Hills, IL (US)

(73) Assignee: Aegis Foods LLC, South Holland, IL (US)

(21) Appl. No.: 18/960,352

(22) Filed: Nov. 26, 2024

Related U.S. Application Data
(60) Provisional application No. 63/603,151, filed on Nov. 28, 2023.

(51) Int. Cl. A23B 5/005

(52) U.S. Cl. CPC A23B 5/0052

(57) ABSTRACT

A continuous feed, shell egg pasteurization system and method uses sprayed heated water. The unpasteurized shell eggs are conveyed and rotated through a horizontal tunnel. An overlapping pattern of heated water is sprayed downward onto the rotating shells eggs. Verified testing shows that the shell eggs achieve a statistical 5 log reduction of Salmonella enteritidis that may have been present in the yolk in the respective unpasteurized shell egg, while at the same time are not overcooked and have little to no whitening of the albumen.

### CROSS-REFERENCE TO RELATED APPLICATION

The present application claims priority of U.S. Provisional Patent Application No. 63/603,151, filed Nov. 28, 2023, the content of which is incorporated herein by reference in its entirety.

### FIELD OF THE INVENTION

The invention relates to shell egg pasteurization processes. In particular, the invention pertains to a continuous feed, horizontal spray bath shell egg pasteurization system and method. The system operates using statistically verified time and temperature protocols to produce pasteurized chicken shell eggs with at least a statistical 5 log reduction of Salmonella enteritidis and consistent quality.

### BACKGROUND OF THE INVENTION

Several patents pertaining to the pasteurization of shell eggs including, for example, U.S. Pat. No. 6,165,538 entitled “Pasteurized In-Shell Chicken Eggs”, by Leon John Davidson, issued on Dec. 26, 2000; U.S. Pat. No. 6,113,961 entitled “Apparatus and Methods for Pasteurizing in-Shell Eggs,” by Louis Polster issued on Sep. 5, 2000, and U.S. Pat. No. 9,289,002, entitled “Shell Egg Pasteurization Method” issuing on Mar. 22, 2016, by Hector Lara et al. describe the use of heated water baths to pasteurize batches of chicken shell eggs. Batches of shell eggs are submerged in a heated water bath and are moved sequentially in stages from zone to zone in the water bath in order to complete the pasteurization process. In these batch water bath systems, it is necessary to inject perturbating air bubbles into the heated water bath to ensure consistent uniform heating of the eggs. Without perturbation, hot spots can occur which can lead to overcooking some of the shell eggs. For several decades, commercial production of pasteurized shell eggs has submerged bathes of shell eggs in a heated water bath.

The present invention does not submerge batches of shell eggs in a heated water bath. Rather, shell eggs are continuously fed onto a conveyor passing through a horizontal tunnel and are sprayed with heated water as they rotate. The shell eggs receive a uniform thermal treatment sufficient for pasteurization and the process provides consistent shell egg quality.

The purpose of the pasteurization process is to heat the shell egg such that the entire egg including the center of the egg yolk warms to an adequate temperature for enough time to meet or exceed the accepted standard for reduction of Salmonella enteritidis set by the FDA. A 5-log reduction of Salmonella enteritidis is the regulated standard set by the FDA (Food and Drug Administration) and WHO (World Health Organization) for pasteurization of in-shell chicken eggs.

It is critical that sufficient heat be provided to meet the 5-log kill standard throughout the entire mass of the egg, including the yolk; however, it is also important that the egg not be overheated during the pasteurization process. There is a market for pasteurized shell eggs which when cracked resemble and function as raw shell eggs. Overheating during the pasteurization process can result in partial cooking or loss of quality and functionality of the shell egg. There are many characteristics pertaining to egg quality and functionality, see for instance the characteristics measured and observed in above referenced Davidson U.S. Pat. No. 6,165,538. One of the most common functionality tests for raw eggs is to measure albumen quality in Haugh units. As an unpasteurized egg ages, the thick inner portion of the albumen tends to thin. Haugh units are calculated using both the egg weight and the height of the inner thick albumen of an egg cracked open on a flat surface. Standard Haugh unit values for different grades of eggs are as follows: Grade AA is greater than 72 Haugh units, Grade A is between 60 and 72 Haugh units, and Grade B is less than 60 Haugh units. The USDA (United States Department of Agriculture) requires that all shell eggs for human consumption be graded both in terms of weight (minimum weight requirements for applicable size e.g.: Medium, Large and Extra-Large) and quality as measured in Haugh units (Grade AA, Grade A, Grade B). It is known in the art, however, that pasteurization leads to higher Haugh unit values compared to a corresponding unpasteurized egg. During the pasteurization process, thermal energy causes the albumen to denature and then cross link, which results in a higher tighter inner albumen and higher Haugh unit values. As more heat is added, the albumen becomes cloudy and eventually begins to coagulate as well. The Davidson '538 patent recognizes that increased Haugh unit values and cloudy egg whites occur with pasteurization.

In prior art batch processing pasteurization equipment using a heated water bath, each batch contains many dozens of eggs typically arranged in flats and stacked one upon another, for example, as described in the incorporated Polster '961 patent and the Lara '002 patent. Prior to pasteurization, the stacks of eggs are staged and held at a uniform start temperature. For example, refrigerated stacks of eggs may be held at 45° F. for storage and then moved to and placed into the pasteurization bath with an egg start temperature of 45° F. Alternatively, refrigerated or unrefrigerated eggs may be tempered to room temperature, e.g., 65° F., prior to being moved to and placed in the pasteurization bath. The batch processing control system is programmed with pasteurization protocols that typically vary water bath temperature and overall dwell time depending on the egg size (e.g., medium size versus large size) and start temperature for the batch. Significant efforts have been made in the art to reliably heat pasteurized shell eggs to consistently achieve the required, accumulated 5-log kill without overcooking the eggs, see e.g., Schuman et al., “Immersion heat treatments for inactivation of Salmonella enteritidis with intact eggs,” Journal of Applied Microbiology 1997, 83, 438-444, and the referenced Davidson '538 patent.

A D-value (measured in minutes) is the amount of time that it takes to achieve a log kill of a pathogen (e.g., Salmonella enteritidis) in a substance held at a certain temperature. D-values for Salmonella enteritidis are known to be higher in egg yolk than in albumen, which means that it is more difficult to kill Salmonella enteritidis in egg yolk than in albumen. Also, heating a shell egg in a water bath requires heat to transfer through the shell and through the albumen to the yolk, so the temperature of the albumen will necessarily be greater than the temperature of the yolk when the egg is coming up to the temperature of the water bath. According to FDA requirements, the yolk temperature must be at least 128° F. before Salmonella enteritidis is killed reliably. As the egg yolk heats from 128° F. to the water bath temperature (“come up time”), the log kill accumulates, and it continues to accumulate as the yolk is maintained at or near the water bath temperature. In fact, log kill continues to accumulate even after the shell egg is removed from the pasteurization bath until the yolk temperature drops below 128° F.

In the water bath batch systems in the prior art, each batch of eggs is held in a carrier that is supported by a gantry located above the water bath and is moved in stages through each of the zones in the water bath. An advance motor moves the respective carriers sequentially from zone to zone at fixed time intervals. A heating system heats the water bath to a thermostatic set point in accordance with the pasteurization protocol selected for the size and the start temperature of the batches of shell eggs being pasteurized. As mentioned, pressurized air is supplied through openings into the water bath to cause perturbation and facilitate effective, uniform heat transfer throughout the stacks of shell eggs on the carriers. Since there is a risk of temperature spikes occurring in the pasteurization bath that can cause overcooking and poor-quality pasteurized eggs, it is known to also provide a cooling system for the pasteurization bath. The cooling system operates to lower the temperature of the water bath as the temperature in the bath approaches an upper temperature limit and in turn mitigates any temperature spikes, see U.S. Pat. No. 9,289,002. The use of a cooling system in this manner enables the pasteurization system to maintain the water bath temperature more aggressively at or near the minimum required temperature for the 5-log time and temperature protocol. This in turn leads to uniform quality of the pasteurized shell eggs.

One of the issues with the batch water bath system is that the thermal load in the first zone is substantially more than the thermal load in the downstream zones. In fact, it is difficult to maintain the water bath temperature at the desired pasteurization temperature (e.g., 134° F.) in the first zone when a batch of refrigerated shell eggs is initially submerged into the first zone. Even if the batch of shell eggs are refrigerated at a pre-selected uniform temperature, the thermal load for each batch can vary substantially depending on shell egg size and weight. This is even true when pasteurizing shell eggs that have been graded at the same weight, such as X-Large, Large or Medium, since there can still be substantial variation in the overall weight of a batch. The bath heating system has to respond aggressively for the initial zone to recover to the pasteurization temperature when the batch is first submerged, but it can be difficult to regulate the water bath temperature under these conditions especially when the thermal load varies for each batch.

After removal from the pasteurization bath, the eggs are sprayed with an antibacterial agent, and coated with food-grade wax or other sealant to protect the eggs from outside contaminants and improve shelf life. Despite the close attention and effort to not overcook and otherwise maintain high quality and functionality standards, those in the art are continually searching for ways to improve the quality and functionality of pasteurized in-shell chicken eggs.

There have been previous attempts to pasteurize shell eggs by spraying heated water on the shell eggs, but these systems have not been used to produce commercially viable pasteurized shell eggs which resemble and function largely as raw shell eggs.

The present invention was developed during efforts to create a continuous feed spray pasteurizing system for shell eggs. The system is similar in some respect to shell egg washers produced by Kuhl Corporation. For example, Kuhl U.S. Pat. No. 4,704,755, entitled “Apparatus for Cleaning Eggs,” issued on Nov. 10, 1987, describes an egg washer in which shell eggs are conveyed under spray nozzles from which cleaning solution is sprayed onto the shell eggs on the conveyor. Cylindrical and flat brushes clean the shell eggs passing on the conveyor. Modern versions of this type of egg washer typically heat the cleaning solution to about 110° F. and use a contoured conveyor holding the shell eggs in line as the eggs are conveyed through the egg washer. The shell eggs rotate as the eggs are conveyed through the egg washer, and the combination of high velocity sprays and brushes removes dirt and other debris effectively.

### SUMMARY OF THE INVENTION

In conducting research on thermal heating of shell eggs, the inventors found surprisingly that spraying heated water continuously downward on rotating shell eggs moving horizontally on a conveyor in a tunnel heated the shell eggs such that the yolks were heated to a predictable and repeatable target temperature. It was also found that the temperature profile of the yolk during come up (e.g., temperature profile from a refrigerated 45° F. to a target yolk pasteurization temperature of e.g., 134° F.) was consistent over time for shell eggs of a given size. In a heated water bath, the target yolk temperature settles at water bath temperature, if the water bath temperature can be held constant. However, when spraying heated water continuously downward on rotating eggs in a tunnel, it was found that the target yolk temperature settles at a temperature incrementally lower than the temperature of the sprayed water. It was found nevertheless that a desired yolk target temperature can be reliably achieved and maintained throughout the entire pasteurization cycle using a continuous downward spray on rotating eggs once the spraying temperature is properly selected. Further, by rotating the eggs in the downward spray of heated water, the eggs can be heated to a yolk target temperature of 134.5° F. without causing the albumen to whiten to any noticeable extent. In water bath systems, whitening can occur due to non-uniform heating from local hot spots or even more general temperature swings in water bath caused by the changing heating requirements when cold batches of eggs are introduced to the bath.

The temperature of the water sprayed can be set and controlled, e.g., an average of 135° F., so that the yolk target temperature (e.g., 134.5° F. within an acceptable tolerance) is obtained reliably for each shell egg without any concern for temperature spikes. The inventive process removes thermal fluctuations that are inherent in water bath systems. Water bath systems often keep the bath at a temperature higher than that desired to avoid whitening of the albumen since the minimum temperature in the bath must be maintained to reliably achieve the 5-log kill threshold. Using higher average bath temperatures is partly required because the local water bath temperature may not be uniform throughout the bath, and also introducing batches of shell eggs periodically into the bath can cause the temperature to drop below the level necessary to achieve the 5-log kill if precautions are not taken. The present invention eliminates the need to accommodate such fluctuations in heating requirements and water temperature. Accordingly, the pasteurization equipment is operated to heat the shell egg and then maintain the shell egg yolk temperature at a desired target temperature, and not at an inflated temperature. This in turn enables the pasteurized hell eggs to receive uniform thermal treatment and avoid overcooking, with the resulting pasteurized shell eggs having consistent quality that resembles and functions similar to a raw, unpasteurized shell egg.

In one aspect, the invention is directed to a continuous-feed, shell egg pasteurization system that provides improved thermal performance and accurate shell egg pasteurization. The continuous-feed, shell egg pasteurization system has a horizontal tunnel with an inlet and an outlet. A roller conveyor extends through the tunnel. The roller conveyer includes a plurality of rollers contoured to hold multiple shell eggs in alignment and driven to rotate the shell eggs as the conveyor moves through the tunnel. In the exemplary embodiment, the conveyor is eighteen (18) shell eggs wide. Unpasteurized shell eggs are placed on the roller conveyor to enter the tunnel through an inlet and pasteurized shell eggs passing through the tunnel exit on the roller conveyor. Desirably, the facility using the pasteurization system has a wall separating post-pasteurization operations from raw shell egg intake operations.

A plurality of sprayers is located above the roller conveyor and spray heated water down on shell eggs rotating on the roller conveyer. A pre-selected protocol sets the temperature of the heated water sprayed from the plurality of sprayers and the time sufficient to ensure that the yolks of the rotating shell eggs are pasteurized to achieve at least a statistical 5-log reduction of Salmonella enteritidis that may have been present in the yolk in the unpasteurized shell eggs. At least one catch basin is located underneath the conveyor to catch water sprayed onto the rotating shell eggs and falling through the conveyor. One or more one pumps recirculate filtered water from the one or more catch basins to the plurality of sprayers. A thermostatically controlled heating system reheats filtered recirculated water and any necessary makeup water to the set spraying temperature.

It is beneficial to have multiple water recirculating and heating zones along the pasteurization system. For example, the heating load in the first zone receiving the shells eggs through the tunnel inlet has a higher heating load than the downstream zones. The system addresses the different heating loads in heating loops that are remote from the shell eggs being pasteurized and is more easily able to maintain the spray temperature in each of the zones. In the exemplary embodiment, there are four zones for recirculating and reheating the water with the common goal of providing a consistent and repeatable thermal experience for the shell eggs. While it is possible to change the temperature for one or more of the zones, the preferred pasteurization protocol uses a spray set temperature of 135° F. for all four zones.

The sprayers are in rows above the upper run of the conveyor and transverse to the direction of the upper run of the conveyor. Each sprayer desirably outputs a spray that forms an overlapping spray pattern such that the shell eggs transported on the conveyor are continuously showered with heated water. The distance between the rows of sprayers and the distance between the sprayers in each row are such that the spray pattern covers the entire region through which the shell eggs pass on the conveyor under the sprayers. In the exemplary embodiment, full square spray nozzles are used. Full square spray nozzles are a type of bathing nozzle, and different from the types of nozzles used in egg washers which impact the eggs at a higher velocity. Nozzles other than full square nozzles may be used, however, it is important that the nozzles be capable of providing a continuous overlapping spray pattern over all the rotating shell eggs as they pass through the tunnel on the upper run of the conveyor. In the described embodiment, the nozzles are placed 7 inches above the centerline of contoured roller conveyors so that the spray travels approximately 6 inches downward from the nozzle to the expected surface of the shell egg which depends on the size of the shell egg. The spray nozzles in each row are attached to a manifold distribution pipe and spaced apart at e.g., 6 inches. The manifold distribution pipes are spaced apart at e.g., 6 inches. This configuration ensures a continuous overlapping spray pattern covering all of the shell eggs moving through the tunnel on the upper run of the conveyor. The desired flow rate of the sprayed water for the overall described system is 2600 to 3600 gallons/minute (650-900 gallons/minutes for each zone).

As mentioned, the zoned heating system heats the recirculated water prior to supplying the recirculated water to the plurality of sprayers. In the exemplary embodiment of the invention, the yolk of the shell eggs is heated to a target temperature of 134.5° F., which requires that the temperature of the water supplied to the sprayers be approximately 135° F. The tunnel retains heat and moisture which helps to maintain consistency and reduce heat loss. Testing has shown that the rotating shell eggs heat evenly and consistently across the conveyer and as the rotating shell eggs move longitudinally through the tunnel on the conveyor. As mentioned, there is no risk of thermal spiking, which in turn means that there is little risk that the albumen will whiten as long as the time and temperature protocol is selected appropriately.

For USDA Large shell eggs, the speed of the conveyer is set for the shell eggs to be located in the tunnel and under the spray of heated water (135° F.) for 56 minutes at a target yolk temperature of 134.5° F. For USDA Medium shell eggs, the speed of the conveyer is set for the shell eggs to be located in the tunnel for less time at a target yolk temperature of 134.5° F. For USDA XLarge or Jumbo shell eggs, the necessary time to achieve a 5-log kill is higher than 56 minutes at a target yolk temperature of 134.5° F. The invention is not limited to operating at the specific time and temperatures described in connection with the exemplary embodiment of the invention. For example, a higher yolk target temperature may be used to reduce production time while still providing the necessary thermal treatment to achieve the required 5 log reduction in Salmonella enteritidis.

Unpasteurized shell eggs are loaded into the pasteurizer from a conventional loading table, e.g., using conventional automated egg loading equipment, which places the unpasteurized shell eggs onto the conveyor eighteen (18) shell eggs across at the tunnel inlet. The pasteurized shell eggs are easily transferred from the conveyor for the pasteurization system to downstream conveyors for post-processing. This loading and unloading process is continuous and results in less breakage than loading and unloading heavy batches of stacked shell eggs such as done in water bath batch systems. When the pasteurized shell eggs exit the pasteurization tunnel, the shell eggs are sprayed with a quaternary solution and then are conveyed through a wall to the post-pasteurization side of the facility, where the shell eggs are dried as is known in the art. Then, the shell eggs are waxed and packaged in flats. The shells are then stamped to identify that the shell eggs have been pasteurized. Thereafter, the shell eggs may be re-packaged and are refrigerated prior to shipping. Packing in the flats is accomplished using automated packers. This continuous process provides very little waste inasmuch as there is very little manual handling of the shell eggs. There is reduced breakage during the overall process compared to batch processing systems. Virtually no shell eggs are fully broken as the shell eggs are loaded onto the conveyor and conveyed through the tunnel to complete the pasteurization process, which is a change from batch water bath systems, and the number of checks or fractures is also reduced from what is expected in batch water bath systems.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a top plan view of a continuous feed, water spray shell egg pasteurization system constructed in accordance with an exemplary embodiment of the invention.

FIG. 1A is a detailed view of the section labelled 1A-1A in FIG. 1, showing the intake assembly and the first pasteurization zone.

FIG. 1B is a detailed view of the section labelled 1B-1B in FIG. 1, showing the outlet from the pasteurization system and the final pasteurization zone.

FIG. 2 is a side elevational view of the continuous feed, water spray shell egg pasteurization system shown in FIG. 1.

FIG. 2A is a detailed view of the section labelled 2A-2A in FIG. 21, showing the intake assembly and the first pasteurization zone.

FIG. 2B is a detailed view of the section labelled 2B-2B in FIG. 2, showing the outlet from the pasteurization system and the final pasteurization zone.

FIG. 3 is a schematic cross section illustrating an overlapping spray pattern in the shell egg pasteurizer of FIGS. 1 and 2.

FIG. 3A is a drawing illustrating the array of spray nozzles and the overlapping spray pattern in one of the zones of the pasteurization system, as viewed from lines 3A-3A in FIG. 3.

FIG. 3B is an enlarged view of a portion FIG. 3A.

FIG. 4 is a heating loop layout for heating recycled and makeup water to a selected temperature for spraying onto rotating shell eggs in one of the zones of the pasteurization system.

FIG. 5 is a colored photograph illustrating cracked pasteurized shell eggs that have been pasteurized in the continuous feed, water spray shell egg pasteurization system of FIGS. 1 and 2.

FIG. 6 is an illustration showing the placement of artificial egg temperature monitors and dataloggers loaded onto a conveyor at the tunnel inlet of an exemplary embodiment of the invention.

FIG. 7 is a plot of average yolk temperature data taken with the artificial egg temperature monitors and dataloggers taken during several pasteurization runs using a system constructed and operated in accordance with the exemplary embodiment of the invention.

### DETAILED DESCRIPTION OF THE DRAWINGS

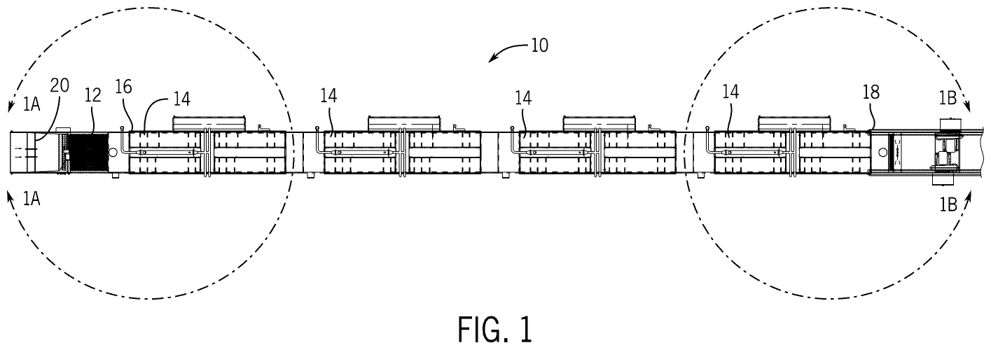

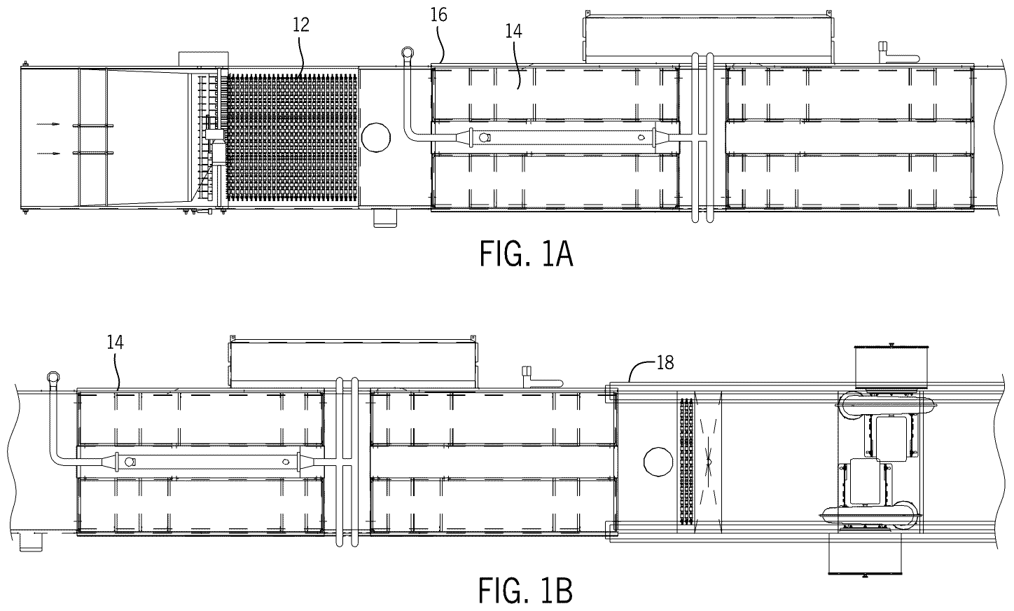

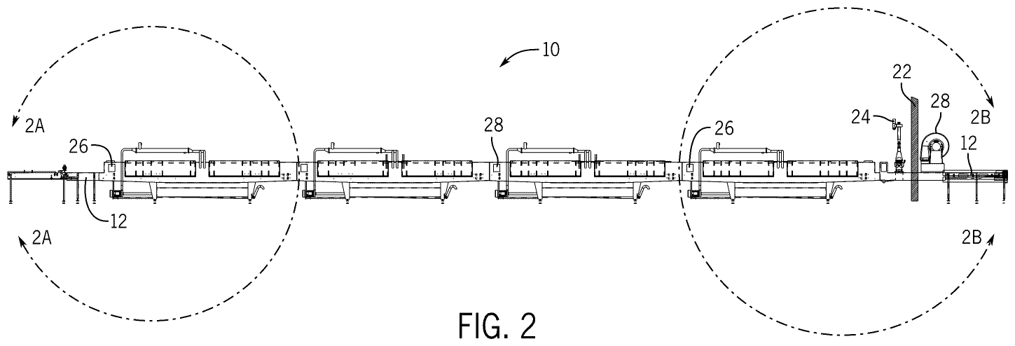

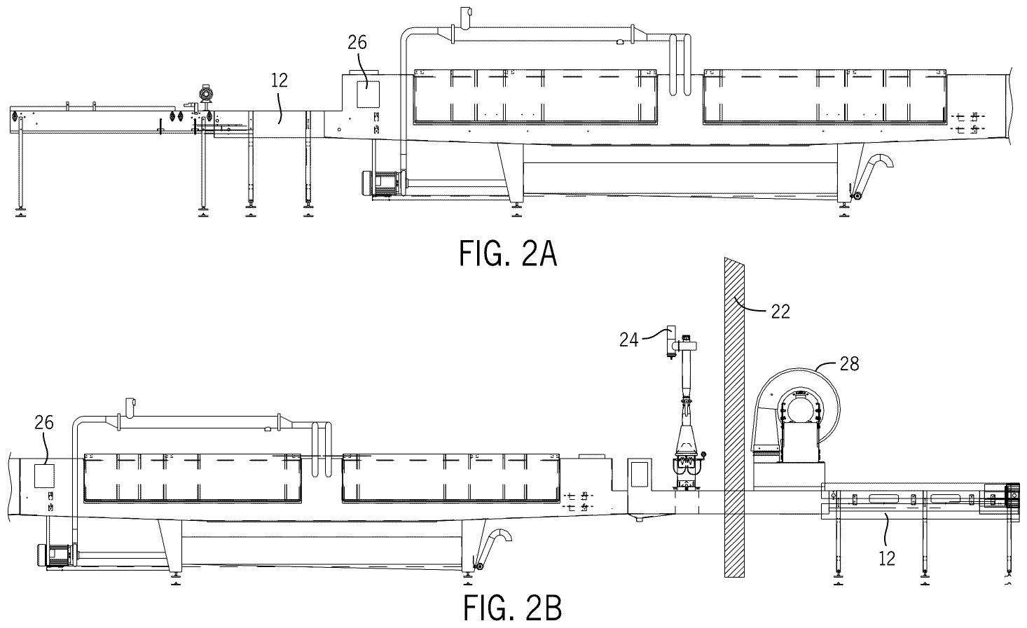

FIGS. 1 and 2 illustrate a shell egg pasteurization system 10 in which shell eggs are continuously transported through a horizontal tunnel 14 and rotated on a conveyor 12 moving through four zones (Zones 1 through 4). In each of the zones, heated water is sprayed downward onto the rotating shell eggs at a prescribed temperature to heat the yolk of each shell egg to a selected target temperature suitable for pasteurization. In the disclosed embodiment, the shell eggs being pasteurized are USDA Large eggs and the yolk target temperature is 134.5° F. To do this, water at 135° F. is continuously sprayed onto shell eggs rotating on an upper run of the conveyor 12 for 56 minutes to achieve a 5-log reduction of Salmonella enteritidis possibly present in the shell eggs prior to pasteurization. The shell egg pasteurization system 10 can operate using different yolk pasteurization target temperatures and heating times, for example if different sized eggs are pasteurized or if it is desired to pasteurize with a lower or higher yolk target temperature and longer or shorter treatment times.

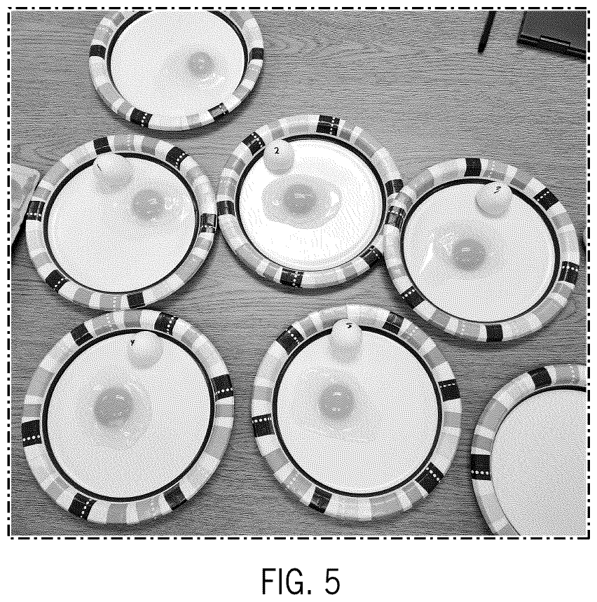

FIG. 5 illustrates cracked pasteurized shell eggs that have been pasteurized in the pasteurizer 10 of FIGS. 1 and 2. The cracked pasteurized shell eggs closely resemble raw unpasteurized eggs. There is virtually no detectable whitening or cloudiness of the albumen in any of the cracked pasteurized eggs. The pasteurization process will typically cause the inner albumen to thicken slightly which will help the yolk sit proudly when the egg is cracked onto a plate. As mentioned, the invention enables the temperature of the water sprayed to be reliably set and controlled, e.g., 135° F., so that the yolk target temperature (e.g., 134.5° F.) is obtained reliably for each shell egg without any concern for overheating. This in turn enables the pasteurized shell eggs to receive uniform thermal treatment and avoid overcooking. The resulting pasteurized shell eggs reliably have consistent quality resembling and functioning similar to a raw, unpasteurized shell egg.

Referring again to FIGS. 1 and 2, the conveyor 12 extends through the tunnel 14 in all four zones 1-4. Each zone is approximately 25 feet long, and the conveyor 12 runs through approximately 100 feet of tunnel 14. The conveyor 12 is approximately 5 feet in width and holds eighteen (18) shell eggs across per row. The inlet 16 to the tunnel 14 is on the left-hand side of FIGS. 1 and 2 and the outlet 18 of the tunnel 14 is on the right-hand side of FIGS. 1 and 2. Unpasteurized shell eggs are loaded onto an intake table 20 upstream of the inlet 16 to tunnel 14. An automated loader (not shown) loads the shell eggs from the intake table 20 and places them in rows on the conveyor 12 upstream of the tunnel inlet 16.

The shell eggs are transported on conveyor 12 through zones 1-4 in which they are heat treated and are discharged from the tunnel exit 18. FIG. 2 shows a wall 22 through which the conveyor 12 extends downstream of the pasteurizer 10. Downstream of wall 22 defines a post pasteurization side of facility. FIG. 2 shows an optional sanitizer applicator 24 on the upstream side of wall 22. The sanitizer applicator 24 dispenses a quaternary solution to treat the shell eggs after they have passed through the pasteurizer 10. Each zone of the pasteurizer has a dedicated electrical junction box 26, and each zone also has a dedicated plumbing and heating loop that provides heated water to the sprayers and also collects used water for recycling and heating.

Referring still to FIG. 2, dryer 28 is located downstream of the wall 22 that separates the post-pasteurization side of the facility from the raw side of the facility. The conveyor 12, or another conveyor moves the shell eggs through the dryer 28 for further processing downstream, which involves waxing of the shell eggs, packaging of the eggs in flats and stamping the shell eggs as pasteurized.

As mentioned, the raw side of the facility is separated by a wall 22 from the post-pasteurized side. Desirably, the facility has designated receiving and shipping docks, separated physically, and unpasteurized and pasteurized shell eggs are stored in separate coolers to prevent contamination after processing. Access to the post-pasteurization side of the facility and the packaging area is restricted to authorized staff. Following pasteurization, pasteurized shell eggs are stamped with a unique symbol, which visually distinguishes pasteurized shell eggs from unpasteurized shell eggs. Pasteurized eggs are placed into shipping boxes immediately after stamping, sealed using tape and plastic wrapper, and stored in the designated cooler (<45° F.) until shipment.

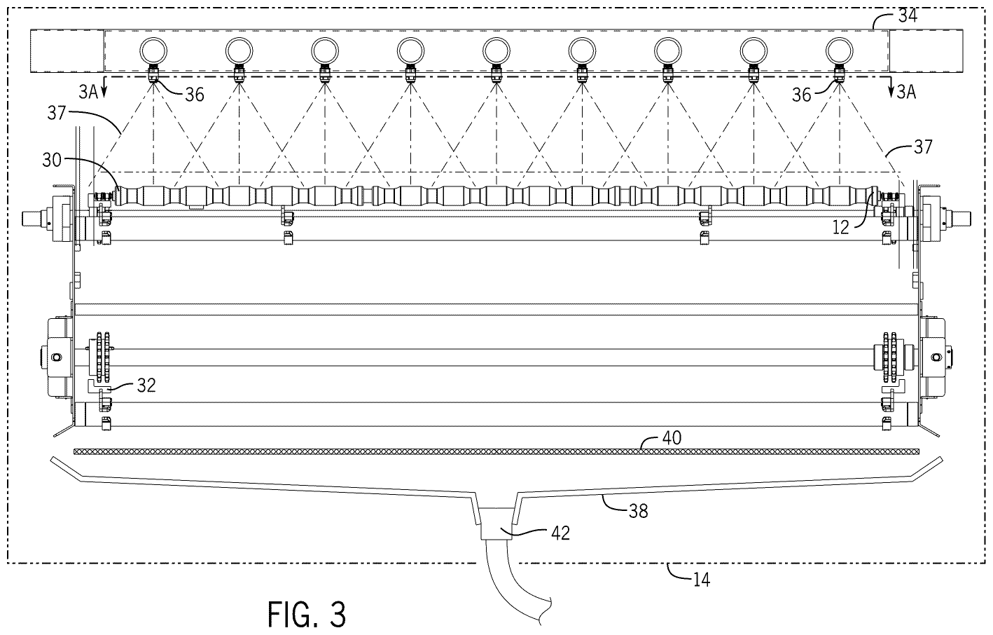

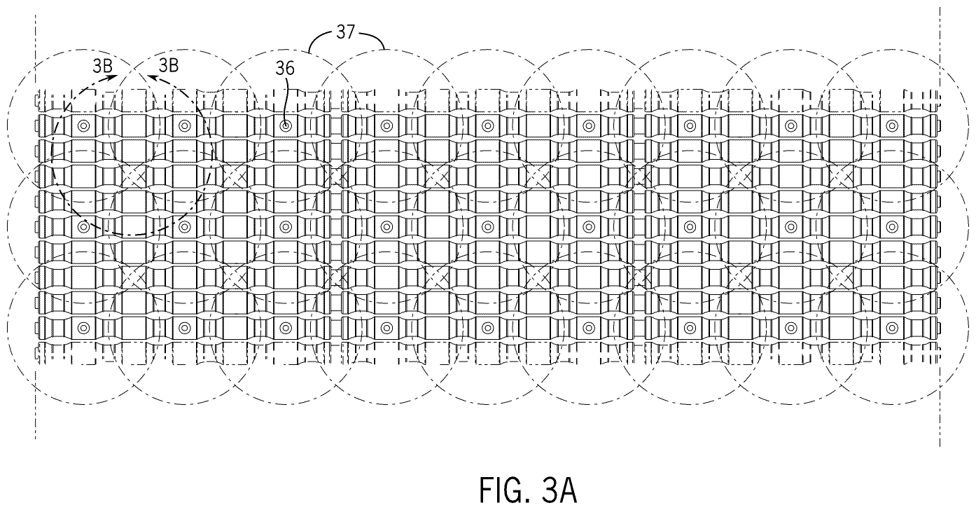

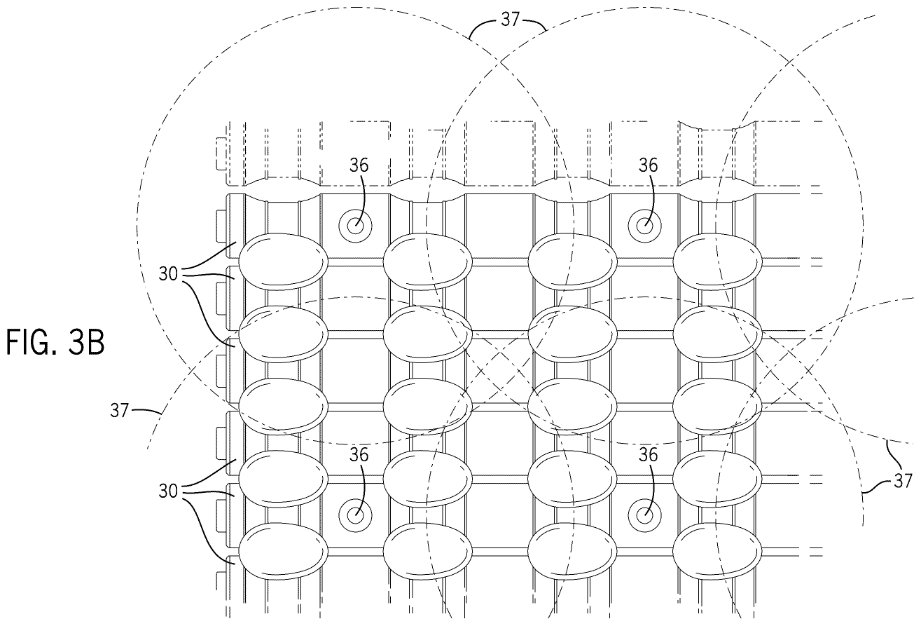

Referring to FIG. 3, the spray nozzles 36 are located in rows above the upper run 30 of the conveyor 12 and transverse to the direction of the conveyor 12 moving through the tunnel 14. Each spray nozzle 36 desirably outputs a spray that forms an overlapping spray pattern with the spray 37 from the adjacent spray nozzle 36. In FIG. 3, there are locations on the contoured roller conveyor 12 for eighteen (18) shell eggs across the conveyor 12. There are nine (9) spray nozzles 36, and as mentioned the spray patterns 37 from the nozzles 36 overlap before the expected top of the rotating shell eggs to form a continuous shower such that the rotating shell eggs transported on the conveyor are continuously showered with heated water. The tunnel 14 is shown schematically in FIG. 3 and it helps maintain a warm, consistent environment for the pasteurization to occur.

A dashed line in FIG. 3 illustrates the expected top of shell eggs rotating on the upper run 30 of the conveyor 12. The distance between the rows of spray nozzles 36 and the distance between the spray nozzles 36 in each row are such that the spray pattern 37 covers the entire region through which the shell eggs pass on the conveyor under the spray nozzles 36. FIG. 3A shows multiple rows of spray nozzles 36 in the tunnel 14 of one of the zones of the pasteurization system 10. The spray patterns 37 are overlapping and form a continuous spray across the entire width of the conveyer 12. FIG. 3B shows an enlarged view with shell eggs on the conveyer. In the exemplary embodiment, full square spray nozzles 36 are used. Full square spray nozzles are a type of bathing nozzle. Nozzles other than full square nozzles may be used, however, it is important that the nozzles be capable of providing a continuous overlapping spray pattern over all the rotating shell eggs as they pass through the tunnel 14 on the conveyor 12. In the disclosed embodiment, the nozzles are placed 7 inches above the contoured rollers on the upper run 30 of the conveyor 12 so that the spray travels approximately 6 inches downward from the respective spray nozzle 36 to the expected location of the top surface of the shell eggs. Of course, the size of the shell eggs varies. Accordingly, the spray nozzles are preferably spaced and set at a height above the conveyor rollers that will ensure spray overlap at the specified spray angle even for XLarge or Jumbo-sized eggs. The spray nozzles in each row are attached to a manifold distribution pipe 34 and spaced apart at e.g., 6 inches. The manifold distribution pipes 34 are spaced apart in parallel rows at e.g., 6 inches. This configuration ensures a continuous overlapping spray pattern covering all of the shell eggs moving through the tunnel on the upper run 30 of the conveyor 12. The desired flow rate of the sprayed water for the overall described system is 2600 to 3600 gallons/minute (650-900 gallons/minutes for each zone). It is possible to change the flow rate within the tolerances of the respective spray nozzles 36 to maintain complete overlapping coverage. Within these ranges, it may be helpful to adjust the flow rate in zone 1 higher to reduce the temperature differential that needs to be addressed when reheating, while reducing the flow rate in the downstream zones where the system only needs to maintain the yolk at the target pasteurization temperature and does not need to heat the entire egg up to the target pasteurization temperature.

FIG. 3 shows a catch basin 38 underneath conveyor 12. There is a separate catch basin 38 for each zone of the pasteurization system 10. An optional screen 40 is located in the catch basin 38 which can be removed in order to clean large sediment such as may occur when there is a broken egg. The catch basin 38 has an outlet 42. There is a fine filter in the outlet line. The filtered water from catch basin 38 is combined with make-up water and is recirculated and reheated.

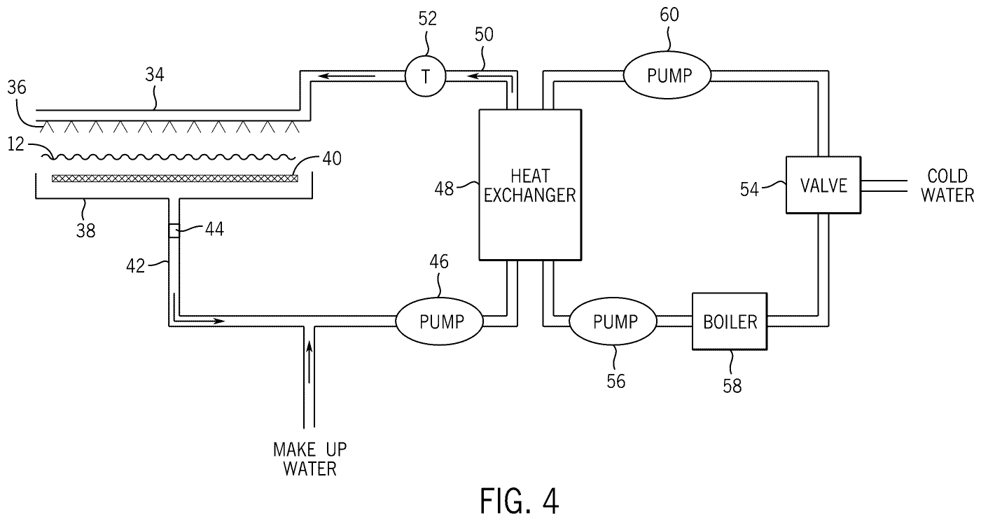

FIG. 4 shows an exemplary plumbing and water reheating loop for one of the zones in the pasteurization system of FIGS. 1 and 2. Referring to FIG. 4, recaptured pasteurization water in pipe 42 from the catch basin 38 is filtered with a fine filter 44 and is circulated by pump 46 to a heat exchanger 48. Make up water is combined with the recirculated water in pipe 42 leading to the pump 46. The pasteurization water loop exits the heat exchanger 48 heated to the desired temperature for spraying (e.g. 134.5° F.) and the heated water is distributed through pipe 50 to the sprayer distribution pipes 34. There is a temperature sensor 52 in line 50 to thermostatically control the temperature of the water being supplied to distribution pipes 34 and spray nozzles 36. The pump 46 preferrable maintains a constant flow rate so that the flow rate through the spray nozzles 36 in the zone does not fluctuate during operation. The temperature sensor 52 provides a signal that is used by a variable speed pump 60 in the boiler loop to control the flow rate of the water inputting the heat exchanger 48 via boiler loop. A pump 56 is provided to pump water through the boiler 58, and then through the valve 54. The valve 54 is thermostatically controlled to maintain the temperature at the inlet of the heat exchanger 48 on the boiler side at a desired temperature. The speed of pump 60 is controlled in order to change the amount of heat transferred to the water flowing through the sprayer side of the heat exchanger.

The exemplary plumbing and water reheating loop has shown to efficiently and accurately heat and re-heat water supplied to the sprayers 36. Nevertheless, alternative means for heating and/or reheating the water supplied to the sprayers may be used to implement the invention.

### Example—Experimental Results for Salmonella enteritidis at 134° F. Yolk Target Temperature

The tests were run on a physical pasteurization system like exemplary embodiment described above in FIGS. 1-4. The physical pasteurization system is a commercial scale, continuous feed, in-shell egg pasteurization system. The system has four heating zones, and each zone has its own temperature probe to monitor the temperature of the heated water continuously with an accuracy of e.g., ±0.5° F. Water temperature data is/was recorded at a 1-min interval.

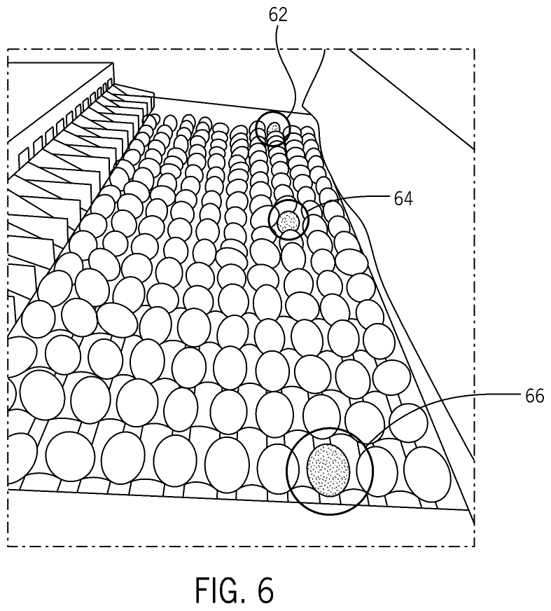

The system was operated as described in the exemplary embodiment above to hold eighteen (18) shell eggs per row on the conveyor, see FIG. 6. As described above, the shell eggs were rotated during processing to ensure that they have full exposure to heated water. Heated water was sprayed through the spray nozzles placed over each position from the entrance to exit of the tunnel to obtain 100% overlapping coverage. The pasteurization process was validated under the maximum throughput values during trials, under the following conditions: 1) USDA Large eggs refrigerated; 2) heated water set temperature 135° F.; 3) 56-minute heat treatment; 4) egg rotation frequency of 15 Hz; 5) total throughput (eggs/hour) 840 dozens/h.

The temperature of shell eggs was monitored using an egg-shaped temperature data logger (MadgeTech, Warner, NH). The temperature mapping of the process was performed in triplicate. Three data loggers were placed on the conveyor belt, one on the left side, one in the center, and one on the right side. The dataloggers are identified with reference numbers 62, 64 and 66 in FIG. 6. The dataloggers used in this study have been previously verified to provide accurate temperature readings compared to a thermocouple being placed through the egg shell into the yolk of the a USDA Large egg. The trials were performed with the pasteurization system at full capacity as the worst-case scenario.

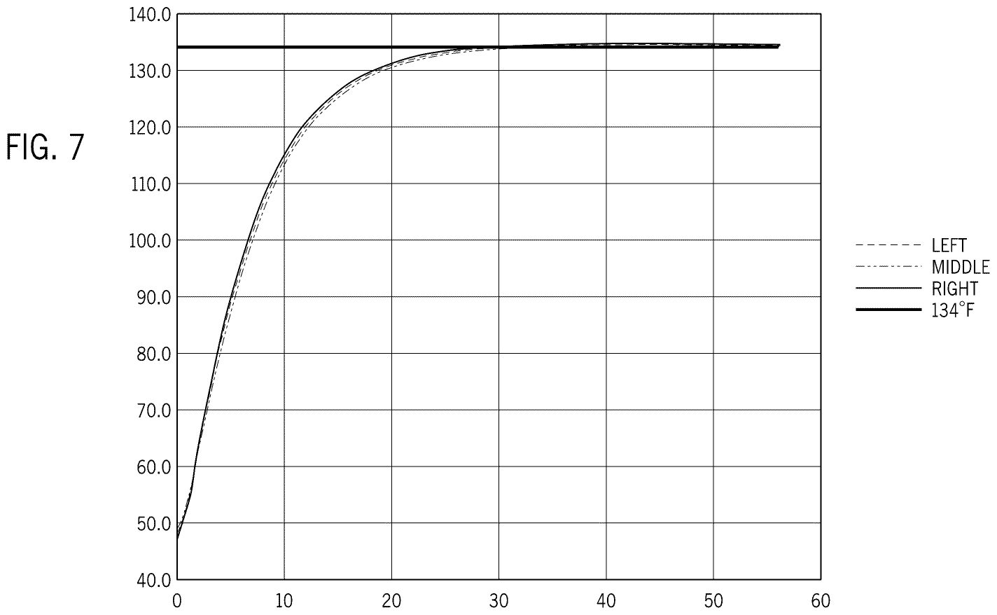

Temperature measurements from the three locations 62, 64, 66 on the conveyor (i.e. left, center and right) were statistically compared with the 95% confidence interval. The results are plotted in FIG. 7. As can be seen in FIG. 7, testing validated that the thermal process for 56 min and exceeds the target yolk temperature of 134° F. Three independent trials were conducted to determine the egg yolk temperature over time at the three positions 62, 64 and 66 as the eggs pass through the pasteurization system. FIG. 8 graphically depicts the average of the independent trials. Temperature data were analyzed when the egg temperature reached >133.5° F. No significant differences were detected in the egg temperature among the three locations tested (left, center and right) in the pasteurizer. Further, a steady yolk temperature was achieved after approximately 30 minutes of treatment in the pasteurization system. The average temperatures between 30-56 min were 134.4° F. (±0.17) for the left, 134.4° F. (±0.16) for the center, and 134.5° F. (±0.16) for the right side.

The cumulative lethality of a cocktail including Salmonella enteritidis was calculated for each the three locations tested (left, center and right) in the system using the thermal death time values reported in Davidson '538 patent for pasteurized in-shell chicken eggs (1). The minimum calculated log reduction of Salmonella was 5.6 log CFU/g. Also, as previously described, FIG. 5 shows photographs of cracked shell eggs pasteurized in accordance with the above protocol. The cracked pasteurized shell eggs in FIG. 5 closely resemble raw unpasteurized eggs, and there is virtually no detectable whitening or cloudiness of the albumen in any of the cracked pasteurized eggs. The pasteurization process will typically cause the inner albumen to thicken slightly which will help the yolk sit proudly when the egg is cracked onto a plate, however.

Accordingly, testing has verified that a commercial scale, continuous feed in-shell egg pasteurizer constructed in accordance with the invention is capable of reliably providing specific thermal treatment homogeneously to every shell egg. It has also verified that, when the spray temperature is set to 135° F. for 56 min (for refrigerated USDA Large eggs), the pasteurizer achieves a minimum of 5.6 log reduction of Salmonella, and that it does so without causing the albumens of the pasteurized shell eggs to whiten or cloud.

The invention is not limited to the specific time and temperature protocols described above in connection with the exemplary embodiment. The invention, however, enables the use of relatively high spray temperatures without causing whitening of the albumen in cracked eggs. For example, shell eggs pasteurized commercially in 135° F. water baths are susceptible to whitening, which means that commercial water bath pasteurization systems need to operate at lower temperatures and higher production times than required by the invention, in order to ensure the minimum 5 log reduction of Salmonella and avoid whitening.

1. A continuous feed, water spray bath shell egg pasteurization system comprising:
a horizontal tunnel having an inlet and outlet;
a roller conveyor extending through the horizontal tunnel, the roller conveyer includes a plurality of rollers to hold shell eggs and rotate the shell eggs as the conveyor moves through the tunnel, wherein unpasteurized shell eggs are placed on the roller conveyor to enter through the tunnel inlet and pasteurized shell eggs pass through the tunnel outlet on the roller conveyor;
a plurality of spray nozzles located above the roller conveyor which spray heated water down on rotating shell eggs on the roller conveyer in accordance with a pre-selected protocol setting a spray temperature of the heated water sprayed from the plurality of sprayers and a time sufficient to ensure that the yolk of the rotating shell eggs are pasteurized to achieve at least a statistical 5 log reduction of Salmonella enteritidis that may have been present in the yolk in the unpasteurized shell eggs;
at least one catch basin underneath the conveyor to catch water spayed onto the rotating eggs on the conveyor;
at least one pump to recirculate the water from the at least one catch reservoir to the plurality of sprayers; and
a heating system to heat the recirculated water prior to supplying the recirculated water to the plurality of sprayers.

2. The continuous feed, water spray bath shell egg pasteurization system recited in claim 1 further comprising a temperature sensor that senses the temperature of heated water being supplied to the plurality of spray nozzles and outputs a signal to a control system, wherein the control system instructs the heating system maintains the temperature of the water being supplied to the spray nozzles at the spray temperature set in the pre-selected protocol.

3. The continuous feed, water spray bath shell egg pasteurization system recited in claim 1 further comprising a removable filtering screen in said catch basin.

4. The continuous feed, water spray bath shell egg pasteurization system recited in claim 1 wherein the system comprises multiple water recirculating and reheating zones along the tunnel and the conveyor, where each zones has an independent plumbing and reheating loop for the spray water, and each of the multiple zones for water recirculating and reheating heats the water supplied to the spray nozzles to said spray temperature set in the pre-selected protocol.

5. The continuous feed, water spray bath shell egg pasteurization system recited in claim 1 wherein each zone has a dedicated controller, and a temperature sensor that senses the temperature of heated water being supplied to the plurality of spray nozzles in the respective zone, wherein each temperature sensor outputs a signal to the control system for the respective zone and the control system controls operation of the zone heating system to maintain the temperature of the water being supplied to the spray nozzles in the respective zone at said spray temperature set in the pre-selected protocol.

6. The continuous feed, water spray bath shell egg pasteurization system recited in claim 1 wherein the spray nozzles are located in rows above the conveyor and transverse to the direction that the conveyor moves said shell eggs; and each sprayer outputs a spray that forms an overlapping spray pattern such that all the shell eggs transported on the conveyor are continuously sprayed with heated water.

7. The continuous feed, water spray bath shell egg pasteurization system recited in claim 1 wherein a distance between the rows of spray nozzles and a distance between the spray nozzles in each row are such that the spray pattern covers the entire region through which the shell eggs pass on the conveyor under the spray nozzles.

8. The continuous feed, water spray bath shell egg pasteurization system recited in claim 1 wherein the spray nozzles are full square spray nozzles which produce a bathing spray.

9. The continuous feed, water spray bath shell egg pasteurization system recited in claim 6 wherein the spray nozzles in each row are attached to a manifold distribution pipe which in turn are attached to a heated water supply pipe.

10. A method of pasteurizing shell eggs comprising the steps of:
providing a horizontal tunnel having an inlet and outlet;
providing a roller conveyor that extends through the horizontal tunnel, the roller conveyer includes a plurality of rollers to hold shell eggs and rotate the shell eggs as the conveyor moves through the tunnel;
providing a plurality of spray nozzles located above the roller conveyor in the tunnel to spray heated water down on rotating shell eggs on the roller conveyer;
placing unpasteurized shell eggs on the roller conveyor to enter through the tunnel inlet;
moving the shell eggs through the tunnel on the conveyor such that the shell eggs are rotated as the conveyor moves the shell eggs through the tunnel; and
sprayed heated water downward on the rotating shell eggs as the conveyor moves the shell eggs through the horizontal tunnel, wherein the spraying temperature of the heated water is set according to a pre-selected protocol setting the temperature of the heated water sprayed and a speed of the conveyor is set so that the time each rotating shell eggs is sprayed with heated water is sufficient to ensure that the yolk in each rotating shell egg is pasteurized to achieve at least a statistical 5 log reduction of Salmonella enteritidis that may have been present in the yolk in the respective unpasteurized shell egg.

11. The method of pasteurizing shell eggs recited in claim 10 wherein the spray nozzles are located above the conveyor and provide an overlapping spray pattern that provides complete coverage of shell eggs located on the conveyor and being moved through the horizontal tunnel.

12. The method of pasteurizing shell eggs recited in claim 11 wherein the temperature of the water sprayed is set and controlled so that yolks of the shell eggs being pasteurized reaches and is maintained at a yolk target temperature of no less than 134° F.

13. The method of pasteurizing shell eggs recited in claim 10 further comprising the steps of:
conveying the pasteurized shell eggs from the tunnel through a tunnel outlet using the roller conveyor; and
continuing to convey the pasteurized shell eggs a wall separating post-pasteurization operations from raw shell egg intake operations.

14. The method of pasteurizing shell eggs recited in claim 13 further comprising the steps of: treating the shell eggs with a quaternary solution prior to conveying the pasteurized shell eggs through the wall to the post-pasteurization side of the facility.

15. The method of pasteurizing shell eggs recited in claim 10 further comprising the steps of:
recovering water sprayed onto the rotating eggs;
filtering the recovered water;
providing make-up water;
pumping the filtered and recovered water and the make-up water to a heat exchanger;
reheating the filtered and recovered water and the make-up water in the heat exchanger to the spraying temperature set in the pre-selected protocol;
supplying the reheated water to the plurality of spray nozzles;
measuring the temperature of the water being supplied to the spray nozzles;
thermostatically controlling the flowrate on the boiler side of the heat exchanger order to reheat the filtered recirculated water and any necessary makeup water to the set spraying temperature.

16. The method of pasteurizing shell eggs recited in claim 10 wherein multiple water recirculating and heating zones are provided along the horizontal tunnel and the conveyor, and each of the multiple zones for water recirculating and reheating heats the water supplied to the spray nozzles to said spraying temperature set in the pre-selected protocol.

17. The method of pasteurizing shell eggs recited in claim 10 wherein the spray nozzles are located in rows above the conveyor and transverse to the direction that the conveyor moves said shell eggs; and each sprayer outputs a spray that forms an overlapping spray pattern such that all the shell eggs transported on the conveyor are continuously sprayed with heated water.

18. The method of pasteurizing shell eggs recited in claim 10 wherein the shell eggs are USDA Large shell eggs, and the yolk of the shell eggs is heated to a target temperature of 134° F., and the shell eggs contained in the horizontal tunnel on the conveyor for 56 minutes.

19. The method of pasteurizing shell eggs recited in claim 11 wherein the set spray temperature is between 0.5° F. and 2.0° F. above the target yolk temperature.

20. The method of pasteurizing shell eggs recited in claim 11 further comprising the steps of: loading unpasteurized shell eggs onto the conveyor using a loading table.
